(19) United States
(12) Patent Application Publication
(10) Pub. No.: US 2025/0291201 A1
(43) Pub. Date: Sep. 18, 2025

(54) FLOATING IMAGE DISPLAY DEVICE AND METHODS FOR OPERATING THEREOF, INTERACTIVE FLOATING IMAGE DISPLAY SYSTEM, METHOD FOR OPERATING INTERACTIVE FLOATING IMAGE DISPLAY SYSTEM

(71) Applicant: Samsung Electronics Co., Ltd., Suwon-si (KR)

(72) Inventors: Ilia Valer'evich MALYSHEV, Leningradskaya region (RU); Svetlana Vladimirovna DANILOVA, Moscow region (RU); Stanislav Aleksandrovich SHTYKOV, Moscow (RU); Alexander Alekseyevich ASPIDOV, Moscow (RU); Nikolay Victorovich MURAVEV, Moscow region (RU)

(21) Appl. No.: 19/222,661

(22) Filed: May 29, 2025

Related U.S. Application Data
(63) Continuation of application No. PCT/KR2023/020426, filed on Dec. 12, 2023.

(30) Foreign Application Priority Data
Dec. 15, 2022 (RU) 2022132978

(51) Int. Cl. G02B 30/56; H04N 13/327; H04N 13/398

(52) U.S. Cl. CPC G02B 30/56; H04N 13/327; H04N 13/398

(57) ABSTRACT

The disclosure relates to optical engineering and provides augmented reality devices that form volumetric floating images in a free space. A floating image display device comprises an image source, an electronic control unit including circuitry, a tunable optical power system including an optically active material, a projection unit including a projector, and a waveguide system including at least one waveguide.

### CROSS-REFERENCE TO RELATED APPLICATIONS

This application is a continuation of International Application No. PCT/KR2023/020426 designating the United States, filed on Dec. 12, 2023, in the Korean Intellectual Property Office and claiming priority to Russian Patent Application No. 2022132978, filed on Dec. 15, 2022, in the Russian Patent Office, the disclosures of each of which are incorporated by reference herein in their entireties.

### BACKGROUND

### Field

The disclosure relates to optical engineering and integrated optical devices, for example, augmented reality devices that form volumetric floating images in a free space.

### Description of Related Art

The actively developing field of mobile technologies requires ever more ingenious solutions possessing high information content and comfort. One idea that requires technical implementation is a floating image display device with increased field of view, which performs displaying without additional diffusing medium. This display should meet the following demands:
enlarged, color, high quality volumetric image;
wide field of view so that the image can be viewed from multiple viewpoints or by multiple users;
image should be placed in front of the display plane, e.g., have a positive relief;
no moving parts;
safe and contactless user interface.

Augmented reality glasses are based on a waveguide, in-coupling and out-coupling diffractive optical element (DOE), in such systems the image field of view is rather small, and the image brightness is highly dependent on the viewing angle. There are also augmented reality glasses based on an architecture comprising multiple in-coupling, out-coupling and multiplying DOEs, in such systems, the image field of view of the image increases. There also exist systems for displaying a floating image for mobile devices, in such systems the image field of view is increased compared to the field of view obtained in augmented reality glasses, and, in addition, the image can be viewed by several users at the same time. However, in such systems, the size of floating image itself is small, and it is difficult to achieve good brightness, image uniformity and image quality when scaling it.

### SUMMARY

Embodiments of the disclosure may provide a device to obtain a volumetric floating image with an enlarged field of view, wherein the volumetric floating image is to be displayed in a space without an additional diffusing medium. Thus, the image can be viewed from several points of view and/or by several users. Moreover, the device for displaying a volumetric floating image may not include moving parts and have a safe and non-contact user interface.

According to an example embodiment, there is provided a floating image display device, comprising:
an image source comprising memory;
an electronic control unit comprising circuitry;
a tunable optical power system comprising an optically active material;
a projection unit including a projector; and
a waveguide system including a waveguide.

The image source is connected to the electronic control unit and configured to store a digitized image in the memory and output to the electronic control unit, the digitized image in a form of a signal containing data of an initial image and information on a distance from the floating image display the device, at which an image corresponding to the initial image is to be formed.

The electronic control unit is connected to the tunable optical power system and to the projection unit, the electronic control unit being configured to divide said signal into a signal containing initial image data and a signal containing data of voltage whose value corresponds to the distance information.

The projection unit is optically coupled to the waveguide system and is configured to convert the signal containing the data of the initial image into a light field corresponding to the initial image.

The waveguide system is optically coupled to the tunable optical power system and is configured to multiply light beams making up said light field.

The tunable optical power system comprises a polarizer, an element (e.g., at least one lens) with a first optical power, an element (e.g., at least one lens) with a second optical power and a tunable optical element located between said the first and second elements.

The polarizer is configured to polarize the multiplied light beams out-coupled from the waveguide system such that polarization direction of said light beams coincides with polarization direction of the tunable optical element.

The element with a first optical power is configured to direct the polarized light beams that have passed through the polarizer toward the tunable optical element.

The tunable optical element (e.g., a liquid crystal or birefringent material) is configured to introduce a phase delay to wavefront of the passing light field, thereby changing the distance at which a floating image is to be formed in a space, under the effect of voltage applied by the electronic control unit.

The element with a second optical power is configured to focus said light beams making up the light field corresponding to the initial image and out-coupled from the tunable optical element, in the space, forming a floating image at a distance corresponding to the voltage applied to the tunable optical element.

Furthermore, the element with a first optical power can be a positive optical power element, and the element with a second optical power can be a negative optical power element. Optical power Dₚₒₛ of the positive optical power optical element can be related to optical power D_{Neg} of the negative power optical element as:

D_{Pos}=−1.1×D_{Neg}.

The first element may include a negative optical power element, and the second element may include a positive optical power element. The first element may include a positive optical power element, and the second element may include a negative optical power element. There may be no air gap between the element with a first optical power, the tunable optical element and the element with a second optical power. The image source may comprise the memory of electronic device. The tunable optical element may comprise a liquid crystal layer. The tunable optical element may comprise an optically active material that changes optical properties under the effect of voltage (e.g., may include a birefringent material). The image source may comprise the memory storing data on each slice of the image, including a digitized image of a slice and data on a slice depth.

According to an example embodiment, there is also provided a method for operating a floating image display device for displaying a flat floating image, comprising:
A) outputting, by an image source, a digitized initial flat image, which enters an electronic control unit comprising circuitry, wherein the digitized initial flat image is a signal containing data of the digitized initial flat image and information on the distance at which a flat floating image, corresponding to the digitized initial flat image, is to be formed;
B) processing, by the electronic control unit, the signal, dividing, by the electronic control unit, the signal into a signal containing said the digitized initial flat image data and a voltage signal whose value corresponds to the information on the distance to the floating image display device, at which the flat floating image is to be formed;
C) applying, by the electronic control unit, a voltage corresponding to the voltage signal to a tunable optical element comprising an optically active material;
D) sending to a projection unit, comprising a projector, by the electronic control unit, the signal containing said initial flat image data;
D) converting, by the projection unit, the initial flat image data into a light field corresponding to the initial flat image, and projecting, by the projection unit, said light field to a waveguide system;
E) multiplying, by the waveguide system, a set of light beams comprising the light field;
F) polarizing, using a polarizer of the tunable optical power system, the multiplied light field out-coupled from the waveguide system;
G) applying the polarized light field to an element including at least one lens with a first optical power, then to the tunable optical element, wherein under the effect of said voltage, the tunable optical element is tuned such that the light field that has passed through the tunable optical element and an element including at least one lens with a second optical power, forms a flat floating image corresponding to the initial flat image in a space at a distance corresponding to the applied voltage.

According to an example embodiment, there is provided a method for operating a volumetric floating image display device, comprising:
A) rendering, by a computer-aided design (CAD) system, a digitized initial volumetric image into a sequence of digitized flat slices of the volumetric image;
wherein each digitized flat slice of the volumetric image is a signal containing data of flat slice image of the volumetric image and information on the distance at which the floating image of the flat slice of the volumetric image is to be formed;
transmitting the sequence of digitized flat slices as a sequence of signals to an image source;
B) transmitting said sequence of signals from the image source to an electronic control unit comprising circuitry;
processing each signal from the sequence, by the electronic control unit, dividing the signal into a signal containing image data of the flat slice of the volumetric image and a voltage signal whose value corresponds to information on the distance from the floating image display the device, at which a floating image of the flat slice of the volumetric image is to be formed;
C) applying to a tunable optical element, by the electronic control unit, successively with a time shift, at a frequency exceeding the ability to see images as distinct images for the observer:
voltages corresponding to voltage signals for the floating image of the volumetric image flat slice for each flat slice image of the volumetric image from the sequence;
D) applying to a projection unit, comprising a projector, by the electronic control unit, successively with a time shift, at a frequency exceeding the ability to see images as distinct images for the observer:
signals containing image data of the flat slice of the volumetric image for every flat slice image of the volumetric image from the sequence;
wherein
steps C) and D) are carried out synchronously;
successively with a time shift:
E) converting, by the projection unit, the image data of the flat slice of the volumetric image for every flat slice image of the volumetric image from the sequence to a light field, projecting, by the projection unit, each said light field to a waveguide system;
F) multiplying, by the waveguide system, a set of light beams making up each said light field;
G) polarizing, by a polarizer of a tunable optical power system, each multiplied light field out-coupled from the waveguide system;
H) the polarized light field falls on an element with a first optical power, falls on a tunable optical element, and under the effect of said voltage, the tunable optical element is tuned such that the light field that has passed the tunable optical element and an element with a second optical power forms a floating image of the flat slice of the volumetric image in a space at a distance corresponding to the applied voltage;
wherein the sequence of floating images of flat slices of the volumetric image in a space, transmitted at a frequency exceeding the ability to see images as distinct images for the observer, forms a volumetric floating image for the observer.

The initial volumetric image can be an initial volumetric color image;
wherein every digitized flat slice of the volumetric image including a red (R) component, a green (G) component, and a blue (B) component;
wherein said image data of a flat slice of the volumetric image is red (R) image channel data of the flat slice of the volumetric image, green (G) image channel data of the flat slice of the volumetric image, and green (G) image channel data of the flat slice of the volumetric image;
wherein said signal containing image data of the flat slice of the volumetric image and information on the distance at which a floating image of the flat slice of the volumetric color image is to be formed includes:
a signal containing red (R) image channel data of the flat slice of the volumetric color image,
a signal containing green (G) image channel data of the flat slice of the volumetric color image, and
a signal containing blue (B) image channel data of the flat slice of the volumetric color image;
wherein
the distance from the floating image display device, at which a floating image of the red (R) image channel of the flat slice of the volumetric color image is to be formed,
the distance from the floating image display device, at which the floating image of the green (G) image channel of the flat slice of the volumetric color image is to be formed,
the distance from the floating image display device, at which the floating image of the blue (B) image channel of the flat slice of the volumetric color image is to be formed,
are equal to the distance, at which a floating color image of the flat slice of the volumetric color image, corresponding to the initial volumetric color image, is to be formed;
wherein said voltage signal includes:
a voltage signal for the red (R) image channel of the flat slice of the volumetric color image, whose value corresponds to information on the distance from the floating image display device, at which a floating image of the red (R) image channel of the flat slice of the volumetric color image is to be formed,
a voltage signal for the green (G) image channel of the flat slice of the volumetric color image, whose value corresponds to information on the distance from the floating image display device, at which a floating image of the green (G) image channel of the flat slice of the volumetric color image is to be formed,
a voltage signal for the blue (B) image channel of the flat slice of the volumetric color image, whose value corresponds to information on the distance from the floating image display device, at which a floating image of the blue (B) image channel of the flat slice of the volumetric color image is to be formed,
wherein steps (B)-(H) are repeated for every flat slice of the volumetric color image, and the sequence of floating R, G, B images of the flat slice of the volumetric color image components, transmitted at a frequency exceeding the ability to see images as distinct images for the observer, forms a volumetric floating color image for the observer.

According to an example embodiment, there is provided a method for operating a floating image display device for displaying a floating volumetric video, comprising t:
A) rendering, by a CAD system, every digitized initial volumetric image from a sequence of digitized initial volumetric images making up a video image, into a sequence of digitized flat slices of the image,
wherein every digitized flat slice of the image is a signal containing image data of the flat image slice and information on the distance at which the flat image slice floating image is to be formed;
storing the sequence of digitized flat image slices in an image source;
B) transmitting the sequence of digitized flat image slices from the image source to an electronic control unit comprising circuitry;
for every digitized initial volumetric image:
C) processing each signal from the sequence of digitized flat image slices by the electronic control unit, dividing the signal into a signal containing image data of the flat slice and a voltage signal whose value corresponds to information on the distance at which a floating image of the flat slice is to be formed;
D) applying to a tunable optical element comprising an optically active material, by the electronic control unit, successively with a time shift, at a frequency exceeding the ability to see images as distinct images for the observer:
voltages corresponding to voltage signals for floating image of the flat slice for each image of the flat image slice from the sequence of digitized flat slices;
E) applying to a projection unit, comprising a projector, by the electronic control unit, successively with a time shift, at a frequency exceeding the ability to see images as distinct images for the observer:
signals containing flat slice image data for every flat slice image from the sequence of digitized flat image slices;
wherein
D) and E) are carried out synchronously;
successively with a time shift:
F) converting, by a projection unit, the flat slice image data for each flat slice image from the sequence of digitized flat image slices into a light field, projecting, by the projection unit, every said light field to a waveguide system;
G) multiplying, by the waveguide system, a set of light beams making up each said light field;
H) polarizing, by a polarizer of a tunable optical power system, every multiplied light field out-coupled from the waveguide system;
I) the polarized light field falls on an element with a first optical power, falls on a tunable optical element, and under the effect of said voltage, the tunable optical element is tuned such that the light field that has passed the tunable optical element and an element with a second optical power forms a floating image of the flat image slice in a space at a distance corresponding to the applied voltage;
wherein, the sequence of floating flat slice images from the sequence of digitized initial images, which makes up the video, in a space, transmitted at a frequency exceeding the ability to see images as distinct images for the observer, forms a volumetric floating video for the observer.

The initial volumetric image from the sequence of digitized initial volumetric images, making up the video image, can be an initial volumetric color image from a sequence of digitized initial volumetric color images making up a color video image;
wherein each digitized flat color image slice includes a red (R) component, a green (G) component, and a blue (B) component;
wherein said image data of the flat image slice comprises red (R) image channel data, green (G) image channel data, and blue (B) image channel data;
wherein said signal containing image data of the flat image slice and information on the distance, at which a floating image of the flat image slice is to be formed, includes:
a signal containing red (R) image channel data of the color image flat slice,
a signal containing green (G) image channel data of the color image flat slice,
a signal containing blue (B) image channel data of the color image flat slice;
wherein
the distance from the floating image display device, at which a floating image of the red (R) image channel of the color image flat slice is to be formed,
the distance from the floating image display device, at which a floating image of the green (G) image channel of the color image flat slice is to be formed,
the distance from the floating image display device, at which a floating image of the blue (B) image channel of the color image flat slice is to be formed,
are equal to the distance at which a floating color image of the color image flat slice, corresponding to the initial color image, is to be formed;
wherein said voltage signal includes:
a voltage signal for the red (R) image channel of the color image flat slice, whose value corresponds to information on the distance from the floating image display device, at which a floating image of the red (R) image channel of the color image flat slice is to be formed,
a voltage signal for the green (G) image channel of the color image flat slice, whose value corresponds to information on the distance from the floating image display device, at which a floating image of the green (G) image channel of the color image flat slice is to be formed,
a voltage signal for the blue (B) image channel of the color image flat slice, whose value corresponds to information on the distance from the floating image display device, at which a floating image of the blue (B) image channel of the color image flat slice is to be formed,
wherein (B)-(I) are repeated for every flat image slice from the sequence of digitized initial color images, which makes up the video, and the sequence of floating R, G, B images of flat slice components of color images from the sequence of digitized initial color images, which makes up the video in a space, transmitted at a frequency exceeding the ability to see images as distinct images for the observer, forms a volumetric floating color video for the observer.

According to an example embodiment, there is also provided an interactive floating image display system, comprising:
a floating image display device;
a beam splitter;
an infrared (IR) detector;
an IR waveguide disposed between the beam splitter and a waveguide system;
an IR backlight unit including an IR backlight;
a control module comprising circuitry connected to the IR detector and an electronic control unit;
wherein
the electronic control unit is connected to the IR backlight unit and is further configured to send a control signal to the IR backlight unit;
a tunable optical power system is further configured to collimate IR radiation scattered by the user;
wherein the waveguide system is transparent to IR radiation;
the IR backlight unit is configured to illuminate the entire floating image area;
the beam splitter is configured to transmit scattered IR radiation to the IR detector;
the IR detector is configured to detect scattered IR radiation that has passed through the beam splitter and transmit it to a control module;
the control module is configured to detect an interaction with the floating image area, and the place of interaction on the floating image area, and generate a command corresponding to location of the place of interaction with the floating image area.

The IR waveguide can be integrated with the waveguide system. The IR backlight unit can be embedded in the projection unit. The present system can further comprise an array of ultrasonic transmitters which transmits ultrasonic signal to the floating image area for user interaction with the floating image area.

According to an example embodiment, there is provided a method of operating an interactive floating image display system, comprising:
sending, by the electronic control unit, a control signal to the IR backlight unit;
illuminating, by the IR backlight unit, a floating image area with IR radiation;
interacting, by the user, with the floating image area, thereby scattering the IR radiation;
collimating the scattered IR radiation by the tunable optical power system;
directing the collimated scattered IR radiation through the waveguide system, which is transparent to IR radiation, to the IR waveguide;
out-coupling IR radiation from the IR waveguide and directing, through the beam splitter, to the IR detector;
detecting, by the IR detector, scattered radiation and transmitting signals to the control module;
detecting, by the control module, the fact of user interaction with the floating image area and the place of interaction on the floating image area;
generating, by the control unit, a command corresponding to location of the place of interaction on the floating image area.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example structure of a volumetric floating image display device according to various embodiments; and

FIG. 2 is a diagram illustrating an interactive floating image display system according to various embodiments.

### DETAILED DESCRIPTION

According to various example embodiments, there is provided a device for forming a volumetric or non-volumetric floating image focused in a free space, which can be seen with the naked eye in the field of view (FoV) at some distance from the display. The disclosure may combine the use of lenses with opposite optical powers and a tunable optical element between them; in addition, a two-channel user interaction system is provided, which enables forming an image in the visible range of the spectrum, and interacting with the user in the infrared (IR) range of the spectrum.

When using the disclosure, the user can observe a real volumetric or non-volumetric image in a space in a large field of view. The convenience of viewing the image by the user at a distance and the convenience of user interaction with the image are also increased. The floating image display device displays a floating image without an additional diffusing medium, while forming an enlarged high-quality image with a wide field of view. The image may be viewed from several viewpoints by one or more users. Moreover, the display device does not include moving parts and possesses a safe and contactless user interface.

The disclosure increases the efficiency of using radiation directed from a projector, improves image uniformity regardless of the angle at which the user observes the image, ensures high quality of the image, and provides a system for non-contact user interaction with the image.

The floating image display device is compact and slim, while the floating image is volumetric and large. For this, a system is used whose optical power can be tuned, while displaying different image slices, e.g., image frames formed in several planes at different distances from the display device. The observer has a feeling of volume of the image. Furthermore, the tunable optical power system can form a high-quality color image by compensating for chromatic aberrations.

The following terms may be used in the disclosure:

Field of view (angular field) of an optical system may refer to a cone of rays that have left the optical system and form an image at infinity (optical term). Center of the field of view corresponds to center of the floating image, and edge of the field of view corresponds to edge of this image.

Exit pupil (or pupil of optical system) may refer to a paraxial image of the aperture diaphragm in image space, formed by the next part of the optical system in the forward path of rays. This term is well known in optics. A property of exit pupil is that all fields of the image exist at any point in it. By multiplying the exit pupil, its size is increased without resorting to increasing the longitudinal dimensions of the optical system. Classical optics can increase the exit pupil size, but with increasing longitudinal dimensions of the optical system, while waveguide optics can do this without increasing the system size due to the multiple reflection of beams of rays inside the waveguide.

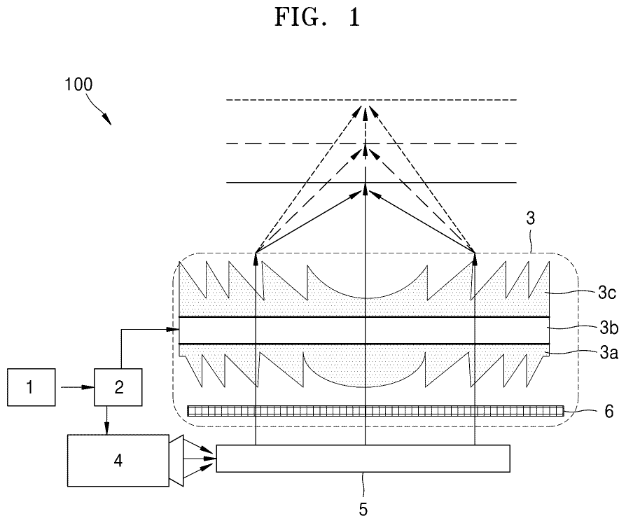

FIG. 1 is a diagram illustrating an example structure of a volumetric floating image display device. The floating image display device 100 comprises an image source 1, an electronic control unit (e.g., including circuitry) 2, a tunable optical power system (e.g., including at least one lens) 3, a projection unit (e.g., including a projector) 4, and a waveguide system (e.g., including at least one waveguide) 5. The tunable optical power system 3 may include a polarizer 6, an element (e.g., a lens) 3a with a first optical power, and an element (e.g., a lens) 3c with a second optical power. The tunable optical power system 3 may further include a tunable optical element (e.g., including an optically active material, such as, for example, and without limitation, a birefringent material, liquid crystal material, or the like) 3b placed between the elements 3a and 3c. The image source 1 is connected to the electronic control unit 2. The electronic control unit 2 is connected to the tunable optical power system 3 and to the projection unit 4. The projection unit 4 is optically coupled to the waveguide system 5. The waveguide system 5 is optically coupled to the tunable optical power system 3.

The floating image display device 100 can be accommodated in the housing of an electronic device, for example, smartphone, computer, laptop, etc. The floating image display device 100 may serve as a display of the electronic device, or work synchronously with other types of displays. In this case the image source may be memory of the electronic device.

The volumetric floating image display device 100 may be disposed outside the electronic device housing; in this case the electronic device memory may act as the image source 1. Connection to the electronic device may be wired and/or wireless. In the volumetric floating image display device outside the electronic device housing, elements of the volumetric floating image display device may be enclosed in a separate body.

Initial volumetric image of a scene or object may be modeled by the artist in an accessible CAD(Computer-Aided Design) system. A file from the CAD system may be loaded/transferred to the image source memory of the floating image display. The CAD system performs rendering, e.g., draws (displays) 3D volumetric image of a scene or object onto flat parts of this volumetric image, which are referred to as slices.

The CAD system is not part of the floating image display device 100 and represents a suitable means whose result is a file that contains a sequence of frames, audio tracks and other information necessary for playing the file, including the depth of image or slice of the volumetric image. Data of each slice of the image includes a digitized image of the slice and data of the slice depth, e.g., the distance from the floating image display device, at which this slice is to be formed (projected). Slices of the volumetric floating image may be flat. Volumetric image (3D model) may be created in any available development environment. The artist only needs to know maximum tuning of the tunable optical power element. Resulting file of the development environments (CAD systems) may be stored in the electronic device memory and processed by the electronic control unit (ECU).

The file with data on 3D model of the scene or object volumetric image, resulting from the 3D model rendering in the CAD system, may be loaded into memory of the image source 1 and stored there, and when this scene or object volumetric image is reproduced, it may enter the electronic control unit 2. In other words, the 3D image processed in the CAD system comprises a set of signals, where each signal carries information on one of volumetric image slices. This information contains data on the slice, as flat image of a part of the entire volumetric image, and on the depth, e.g., the distance from the floating image display device, at which the flat image (slice) is to be formed.

CAD systems that convert volumetric images into a set of signals containing data on each slice as a flat image and on the depth are known to those skilled in the art (for more details, see e.g. Stroud, Ian, and Hildegarde Nagy. Solid modeling and CAD systems: how to survive a CAD system, Springer Science & Business Media, 2011).

In the electronic control unit 2, the depth data is converted into values of voltage that are applied to electrodes of the tunable optical element 3b with a tunable phase delay, so that the image that has passed through the tunable optical power system 3 is formed at the required distance from the floating image display device. Values of voltage applied to electrodes are estimated from the phase-voltage dependence, which is characteristic of any optically active material, e.g., one that is capable of introducing a phase delay when the applied voltage varies with light propagating through it. When choosing an optically active material for the tunable optical element 3b, the dependence of the phase delay of light passing through the material on the voltage at the electrode structure electrodes should be known. The process may be automated using standard algorithms well known in the art (see e.g. US20150277151 A1 (publication date 1 Oct. 2015). The range of possible slice depths, hence the total depth of the scene or object volumetric image, may be limited by tuning range of the tunable optical element 3b. The same restrictions (extreme depth positions) may be also introduced into the CAD model of the scene or object volumetric image.

If initial image of a scene or object is a single flat image contained in memory of the image source 1, the signal transmitted from the image source 1 to the electronic control unit 2 contains flat image data with information on the depth, e.g., the distance from the floating image display device, at which said flat image is to be formed. For a single image, any reachable distance from the tuning range of the tunable optical element 3b may be used. Furthermore, if the image is flat, there is no need to go through the rendering stage to draw slices, since flat image does not have slices. Depth of a single flat image from the possible range of the tunable optical element 3b is estimated and set by the user who creates this image in the CAD system. Depth information may be entered in the file when a single flat image is created.

It should be understood that the floating image display device is capable of reproducing both a single flat image and a volumetric image (e.g., a sequence of slices thereof), or a sequence of such images for reproducing video. As soon as the reproduced file of a single image or a sequence of images (volumetric image or video slices) ends, the device finishes working with this file, and, if there is a request, may open the next file from memory of the image source 1.

The floating image display device may reproduce a single flat floating image, a flat floating video, a volumetric floating image, and a volumetric floating video. The resulting floating image may be either monochrome or color.

The floating image display device may, for example, and without limitation, operate in the following example manner.

To reproduce a flat floating image in a space, the following operations may be carried out.

A) The image source 1 generates and outputs a digitized initial image, or outputs an image stored e.g. in memory of the electronic device. The initial image may be either color or monochrome. The digitized initial image is fed to the electronic control unit 2. The digitized initial image includes a signal containing initial image data and information on the distance from the floating image display device, at which the image corresponding to the initial image may be to be formed.

B) The electronic control unit 2 may process said signal, dividing it into a signal containing initial image data, and a signal containing data on voltage whose value corresponds to the information on the distance from the floating image display device, at which the floating image corresponding to the initial image data is to be formed.

C) The electronic control unit 2 may apply voltage corresponding to the voltage signal to the tunable optical element 3b. Under said voltage, the tunable optical element 3b is tuned such that the light field that has passed through the tunable optical power system 3 forms a floating image corresponding to the initial image at the distance from the floating image display device corresponding to the applied voltage.

D) The electronic control unit 2 may sent a signal containing said image data to the projection unit 4.

C) and D) may be carried out synchronously.

The electronic control unit 2 may include CPU (central processing unit, processor, etc.). The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The electronic control unit 2 processes the received signal and divides it into the image per se for the projection unit 4 and data for the tunable optical power system 3, which is a voltage signal whose value corresponds to the depth information. Such signal processing and separation are known in the art. Examples of such signal processing and separation are known in the data transmission theory in the concept of the Internet of Things (IoT) (see: Shinde G. R. et al. Internet of things augmented reality.-Springer, 2021). The processed depth information may correspond to the value of voltage to be applied to the tunable optical element 3b of the tunable optical power system 3 at the instant when the projection unit 4 projects respective image. When a voltage is applied to the tunable optical element 3b, refractive index of the tunable optical element, and, as a result, optical power of the tunable optical power system 3, change, thus changing the depth (distance) from the floating image display device, at which the floating image will be formed.

The electronic control unit 2 may generate and transmit a signal to the projection unit 4. The signal may be a single image or a sequence of images without information on the image depth.

E) The projection unit 4 may convert the signal containing said initial image data into a light field corresponding to the initial image. The light field comprises a set of light beams that make up the initial image, which propagate at different angles, and rays in each beam propagate parallel to each other. The set of light beams out-coupled from the projection unit 4 corresponds to the initial image, which is projected to the waveguide system 5.

F) The waveguide system 5 may multiply the set of light beams, e.g., the exit pupil aperture of the projection system 4 expands. Such waveguide systems, in which exit pupil aperture of the projection system expands, are widely known (see e.g. U.S. Pat. No. 10,203,762 B2 (publication date 12 Feb. 2019). Thus, a large field of view of the floating flat/volumetric image is achieved. After multiplication, the light beams that make up the light field are decoupled from the waveguide system 5 in an aperture significantly larger than the aperture of the exit pupil of the projection unit 4. At the same time, the angular size of the initial image formed at infinity by the projection unit 4 may be preserved.

G) The multiplied light field may be directed from the waveguide system 5 to the tunable optical power system 3 and enters the polarizer 6. The polarizer 6 polarizes the multiplied light field that has been decoupled from the waveguide system 5.

The polarizer 6 is positioned and oriented such that the set of parallel beams passing through it acquires the polarization direction consistent (coinciding) with the polarization direction of the tunable optical element 3b. It is to be clarified that the tunable optical element 3b includes a material that works only for light with a certain polarization, e.g., light with a different polarization cannot interact with the tunable optical element 3b. The tunable optical element 3b may include a liquid crystal layer (liquid crystal cell), in this case polarization is determined by initial arrangement of liquid crystals in the cell. Also, polymer gels or other optically active materials that change their optical properties under voltage can be used as an optically active material in tunable optical element 3b. Examples of optically active materials suitable for use in accordance with the disclosure will be apparent to those skilled in the art based on the information provided in the present disclosure.

In the case of the disclosure, polarization can be arbitrary, and the light that leaves the waveguide system 5 and passes through the polarizer 6 is such that the material of the tunable optical element 3b is able to process it in the way necessary for this disclosure. Thus, the polarizer 6 accommodates the radiation out-coupled from the waveguide system 5 with parameters of the tunable optical element 3b. Such polarizers are widely known in the art.

H) After polarization in the required plane, the light field falls on the element 3a with a first optical power.

The element 3a with a first optical power and the element 3c with a second optical power may be lenses or lens systems.

The element 3a with a first optical power is located between the polarizer 6 and the tunable optical element 3b. The element 3c with a second optical power is located between the tunable optical element 3b and the user (observer).

The element 3a with a first optical power may be a positive optical power element, then, the radiation that has passed through the element 3a with a first optical power will be focused. In this case, the element 3b with a second optical power may be negative optical power element, then, the radiation transmitted through the tunable optical element 3b will be scattered.

The end result of the tunable optical power system 3 will be focusing the radiation and forming a real image. Owing to just such arrangement, when the optical power of the tunable optical power system 3 changes (under appropriate voltage applied to the tunable optical element 3b), maximum difference is achieved between extreme positions of the focal plane of the tunable optical power system 3, e.g., the most distant position from the floating image display device and the closest position of the focal plane of the tunable optical power system 3 to the device. Thus, the greatest range of scanning through depth of the volumetric floating image is achieved.

To achieve maximum difference between extreme positions of the focal plane, optical power D_{Pos} of the element 3a with a positive optical power may be related to optical power D_{Neg} of the element 3b with a negative optical power as:

D_{Pos}=−1.1×D_{Neg}

It is with this relation the maximum distance between the far and near focus of the entire tunable optical power system 3 may be achieved, thus it is possible to create deep volumetric images, e.g., having large distance between extreme reproducible slices in the floating volumetric image.

The elements 3a and 3c with negative optical power and positive optical power may include any suitable materials, such as glass, plastic, and may also be diffraction gratings and holographic diffraction gratings, may also be meta-lenses, diffractive lenses, liquid crystal lenses, geometric phase lenses, etc.

If a negative lens is placed in front of the liquid crystal layer, and a positive lens is placed behind the liquid crystal layer, then the average optical power of the system decreases, and the image is focused at a longer distance, in this case the user can locate far enough from the display to see the floating image.

It is possible to use two positive lenses, but tuning the focal length in this case will be less than in the case described above, so the effect of the volumetric image will not show up well.

In an example embodiment, a tunable optical power system 3 may have zero air gap between the tunable optical element 3b and the optical elements 3a and 3c. In an embodiment, there may be an air gap between the tunable optical element 3b and the optical elements 3a and 3c; however, in this case, the focal length tuning depth of the entire system will be less than without a gap, and, consequently, a smaller depth of the volumetric image will be achieved.

The electronic control unit 2 applies voltage to the tunable optical element 3b of the tunable optical power system 3 in accordance with voltage signal (step B). Under the effect of the applied voltage, refractive index of the tunable optical element 3b changes, and thereby, due to properties of the tunable optical element material, optical power of the tunable optical power system 3 changes, it refer, for example, to the distance to the floating flat image changing, therefore, there is a change in the depth of the floating image. Thus, the image is focused by the tunable optical power system 3 in a certain focal plane, e.g., at a certain distance from the floating image display device, which corresponds to the voltage applied to the tunable optical element 3b. In turn, the voltage corresponds to the image sent by the electronic control unit 2 to the projection unit 4 and projected by the projection unit 4, thus a flat image or one slice of a volumetric image in the form of a floating image in a space is formed at the distance from the floating image display device. Therefore, the voltage applied to the tunable optical element 3b determines the depth of an individual currently projected image or slice.

Using the above method, both monochrome and color flat floating image or slice can be reproduced in a space. However, due to chromatic aberration, color floating image may break up into red (R), green (G) and blue (G) components, which will be formed at slightly different depths. The disclosure may be implemented without correcting chromatic aberration, but to improve quality of the color floating image, it is possible to correct chromatic aberration.

To reproduce a flat color floating image with corrected chromatic aberration in a space, the following may be carried out.

A) The image source 1 generates a digitized initial color image or outputs such image stored, for example, in memory of an electronic device. The digitized color image includes a signal containing red (R) image channel data, green (G) image channel data, blue (B) image channel data, and information on the distance at which a floating color image, corresponding to the initial color image, is to be formed;
B) The electronic control unit 2 processes the signal, dividing it into the following signals:
a signal containing red (R) image channel data,
a signal containing green (G) image channel data,
a signal containing blue (B) image channel data,
a voltage signal for the red (R) channel of the image, whose value corresponds to information on the distance from the device, at which a floating image of the red (R) channel of the digitized initial color image is to be formed,
a voltage signal for the green (G) channel of the image, whose value corresponds to information on the distance from the device, at which a floating image of the green (G) channel of the digitized initial color image is to be formed,
a voltage signal for the blue (B) channel of the image, whose value corresponds to information on the distance from the device, at which a floating image of the blue (B) channel of the digitized initial color image is to be formed.

The distance from the device, at which a floating image of the red (R) channel of the digitized initial color image is to be formed,
the distance from the device, at which a floating image of the green (G) channel of the digitized initial color image is to be formed,
the distance from the device, at which a floating image of the blue (B) channel of the digitized initial color image is to be formed,
are equal to the distance at which a floating color image corresponding to the initial color image is to be formed.

C) The electronic control unit 2 sends to the tunable optical element 3b successively, with a time shift, at a frequency exceeding the ability to see images as distinct images for a person:
a voltage for the red (R) image channel corresponding to the voltage signal for the red (R) image channel;
a voltage for a green (G) image channel corresponding to the voltage signal for a green (G) image channel;
a voltage for the blue (B) image channel corresponding to the voltage signal for the blue (B) image channel;

D) The electronic control unit 2 sends to the projection unit 4 successively, with a time shift, at a frequency exceeding the ability to see images as distinct images for a person:
a signal containing red (R) image channel data,
a signal containing green (G) image channel data,
a signal containing blue (B) image channel data.

Steps C) and D) are carried out synchronously.

E) The projection unit 4 converts successively, with a time shift:
the signal containing red (R) image channel data into a light field of the red (R) image channel;
the signal containing green (G) image channel data into a light field of the green (G) image channel;
the signal containing blue (B) image channel data into a light field of the blue (B) image channel.

The light field of every image channel is a set of light beams that propagate at different angles, and rays in each beam propagate parallel to each other. The set of light beams out-coupled from the projection unit 4 represents the initial color R, G, B image.

F) The projection unit 4 projects successively, with a time shift:
the light field of the red (R) image channel,
the light field of the green (G) image channel, and
the light field of the blue (B) image channel
to the waveguide system 5.

G) The waveguide system 5 multiplies the set of light beams making up said light fields.

G) The polarizer 6 of the tunable optical power system 3 polarizes the multiplied R, G, B light fields out-coupled from the waveguide system 5.

H) The tunable optical power system 3 forms a floating image in a space at a distance corresponding to the voltage applied to the tunable optical element 3b.

In this case, voltage value for each of R, G, B image components corresponds to the same distance at which a color floating image is to be formed;

I) (B)-(H) are repeated, while R, G, B components of the initial color image and their corresponding depth values remain constant during repetition.

To reproduce a volumetric floating image, both monochrome and color, in a space the following may be carried out.

A) Initial volumetric image (monochrome or color) of a scene or object is modeled in a CAD system. The initial volumetric image of a scene or object is rendered (drawn) into digitized flat slices of the image. Moreover, data on each slice includes a digitized image of the slice and data on the slice depth, e.g., the distance at which this slice is to be formed from the display. The result of the CAD system is a digitized initial volumetric image file including a sequence of digitized flat image slices. Each digitized flat image slice is a signal containing image data of the flat image slice and information on the distance at which a floating image of the flat image slice is to be formed. The digitized initial volumetric image file is transferred to memory of the image source 1.

B) The file, including a sequence of digitized flat slices of the volumetric image, is transmitted from the image source 1 to the electronic control unit 2.

The electronic control unit 2 processes each signal from the above sequence, dividing it into a signal containing image data of a flat slice of the image, and a voltage signal whose value corresponds to information on the distance from the device, at which a floating image of the flat slice of the volumetric image is to be formed.

C) The electronic control unit 2 applies to the tunable optical element 3b, successively, with a time shift, at a frequency exceeding the ability to see images as distinct images for a person:
voltages corresponding to voltage signals for the floating image of the flat slice of the volumetric image for each image of the flat slice of the volumetric image from the sequence.

D) The electronic control unit 2 sends to the projection unit 4, successively, with a time shift, at a frequency exceeding the ability to see images as distinct images for a person:

signals containing image data of the flat slice image for each flat slice image of the volumetric image in the sequence.

C) and D) may be carried out synchronously.

E) The projection unit 4 converts successively, with a time shift, image data of the flat slice for each flat slice image of the volumetric image from the sequence to a light field. Light field comprises a set of light beams that propagate at different angles, and rays in each beam propagate parallel to each other. The set of light beams out-coupled from the projection unit 4 comprises an image of flat slice of the volumetric image. The projection unit 4 then projects each light field successively, with a time shift, into the waveguide system 5;

F) The waveguide system 5 multiplies the set of light beams that make up each light field of the flat slice image from the sequence.

G) The polarizer 6 of the tunable optical power system 3 polarizes light field of each image from the sequence, which has been out-coupled from the waveguide system 5.

H) The polarized light field passes through the element 3a with a first optical power and falls on the tunable optical element 3b, and under the effect of voltage, the tunable optical element 3b is tuned such that the light field that has passed through the tunable optical element 3b and the element 3c with a second optical power forms a real floating image of the image flat slice in a space at a distance corresponding to the applied voltage.

The sequence of floating images of flat slices of the volumetric image in a space, transmitted at a frequency exceeding the ability to see images as distinct images for the observer, forms a volumetric floating image (monochrome or color) for the observer.

To reproduce a flat floating video image, both monochrome and color, in a space the following may be carried out.

A) The image source 1 generates or sends the entire sequence of digitized initial images making up the video. The sequence enters the electronic control unit 2, each digitized initial image from the sequence being a signal containing initial image data and information on the distance at which a floating video is to be formed.

For each digitized initial image from the sequence:
B) The electronic control unit 2 processes said signal, dividing it into a signal containing the initial image data, and a voltage signal whose value corresponds to information on the distance from the device, at which a floating image is to be formed;
C) The electronic control unit 2 applies voltage corresponding to the voltage signal to the tunable optical element 3b;
D) Also, the electronic control unit 2 sends a signal containing said image data to the projection unit 4.
C) and D) may be carried out synchronously.
E) The projection unit 4 converts the image data into a light field corresponding to the initial image. The projection unit 4 projects the light field into the waveguide system 5.
F) The waveguide system 5 multiplies the set of light beams making up said light field.
G) The multiplied light field leaving the waveguide system 5 falls on the polarizer 6 of the tunable optical power system 3, which polarizes the light field passing through it.
H) The polarized light field falls on the element 3a with a first optical power, and then on the tunable optical element 3b. Under the effect of voltage, the tunable optical element 3b is tuned such that the light field that has passed the tunable optical element 3b and the element 3c with a second optical power is forms a real floating image corresponding to the initial image in a space at a distance corresponding to the applied voltage.

The processed digitized initial images from the sequence making up the video image are fed from the electronic control unit 2 at a frequency exceeding the ability to see images as distinct images for the observer, forming a floating video for the observer.

To reproduce a volumetric floating video image, both monochrome and color, in a space the following may be carried out.
A) CAD system renders each digitized initial volumetric image (monochrome or color) from the sequence of digitized initial volumetric images making up the volumetric video image into a sequence of digitized flat slices of each volumetric image from the sequence. Each digitized flat image slice comprises a signal containing image data of the flat image slice and information of the distance at which the flat image slice is to be formed.

The resulting sequence of digitized flat image slices can be stored in the image source 1.

Where necessary, the sequence of digitized flat slices of the image is transmitted from the image source 1 to the electronic control unit 2.

Further, for each digitized initial volumetric image:
B) The electronic control unit 2 processes every signal from the sequence of digitized flat slice images, dividing the signal into a signal containing image data of the flat slice and a voltage signal whose value corresponds to information on the distance at which a floating image of the flat image slice is to be formed.
C) The electronic control unit 2 applies to the tunable optical element 3b of the tunable optical power system 3 successively, with a time shift, at a frequency exceeding the ability to see images as distinct images for the observer:
voltages corresponding to voltage signals for the flat slice floating image for each flat slice image from the sequence of digitized flat image slices.
D) The electronic control unit 2 sends to the projection unit 4 successively, with a time shift, at a frequency exceeding the ability to see images as distinct images for the observer:
signals containing image data of the flat slice for each flat slice image of the sequence of digitized flat image slices.
C) and D) may be carried out synchronously.

Further, successively, with a time shift:
E) The projection unit 4 converts image data of the flat slice for each flat slice image from the sequence of digitized flat image slices into a light field.

The projection unit 4 then projects each said light field into the waveguide system 5.
F) The waveguide system 5 multiplies the set of light beams making up each said light field.
G) The polarizer 6 of the tunable optical power system 3 polarizes every multiplied light field out-coupled from the waveguide system.
H) The polarized light field falls on the element 3a with a first optical power, and then on the tunable optical element 3b. Under the effect of voltage, the tunable optical element 3b is tuned such that the light field that has passed the tunable optical element 3b and the element 3c with a second optical power is forms a real floating image of the image flat slice in a space at a distance corresponding to the applied voltage.

The resulting sequence of floating images of flat slices from the sequence of digitized initial volumetric images that make up the video in a space, transmitted at a frequency exceeding the ability to see images as distinct images for the observer, forms a floating volumetric video for the observer.

To reproduce a color volumetric floating image in a space, the following may be carried out.
A) Initial color volumetric image of a scene or object is modeled in a CAD system. The initial scene or object color volumetric image is rendered into a sequence of digitized flat slices of the color image, each digitized flat slice of the color image including a red (R) component, a green (G) component and a blue (B) component.

Furthermore, each digitized flat slice of the color image comprises a signal containing red (R) image channel data, green (G) image channel data, blue (B) image channel data and information on the distance at which a floating image of the color image flat slice is to be formed.

The sequence of digitized flat slices of the color image is transmitted as a sequence of signals to the image source 1.

From the image source 1, the sequence of signals is transmitted to the electronic control unit 2.

B) The electronic control unit 2 processes each signal from the sequence, dividing it into:
a signal containing red (R) image channel data of the color image flat slice,
a signal containing green (G) image channel data of the color image flat slice,
a signal containing blue (B) image channel data of the color image flat slice,
a voltage signal for the red (R) image channel of the color image flat slice, whose value corresponds to information on the distance from the device, at which a floating image of the red (R) image channel of the color image flat slice is to be formed,
a voltage signal for the green (G) image channel of the color image flat slice, whose value corresponds to information on the distance from the device, at which a floating image of the green (G) image channel of the color image flat slice is to be formed,
a voltage signal for the blue (B) image channel of the color image flat slice, whose value corresponds to information on the distance from the device, at which a floating image of the blue (B) image channel of the color image flat slice is to be formed.

In this case, the distance from the device, at which a floating image of the red (R) image channel of the color image flat slice is to be formed, the distance from the device at which a floating image of the green (G) image channel of the color image flat slice is to be formed, and the distance from the device, at which a floating image of the blue (B) image channel of the color image flat slice is to be formed are equal to the distance at which a floating color image of the color image flat slice corresponding to the initial color image is to be formed.
C) The electronic control unit 2 sends to the tunable optical element 3b for each flat slice of the color image successively, with a time shift, at a frequency exceeding the ability to see images as distinct images for the observer:
a voltage for the red (R) image channel corresponding to the voltage signal for the red (R) image channel of the color image flat slice;
a voltage for the green (G) image channel corresponding to the voltage signal for the green (G) image channel of the color image flat slice;
a voltage for the blue (B) image channel corresponding to the voltage signal for the blue (B) image channel of the color image flat slice.
D) The electronic control unit 2 sends to the projection unit 4 for each flat slice of the color image, successively, with a time shift, at a frequency exceeding the ability to see images as distinct images for the observer:
a signal containing red (R) image channel data,
a signal containing green (G) image channel data,
a signal containing blue (B) image channel data.

Steps C) and D) are carried out synchronously;
E) The projection unit 4 converts for each flat slice of the color image successively, with a time shift:
the signal containing red (R) image channel data into a light field of the red (R) image channel of the color image flat slice;
the signal containing green (G) image channel data into a light field of the green (G) image channel of the color image flat slice;
the signal containing blue (B) image channel data into a light field of the blue (B) image channel of the color image flat slice.
F) The projection unit projects for each flat slice of the color image successively, with a time shift:
the light field of the red (R) image channel of the color image flat slice,
the light field of the green (G) image channel of the color image flat slice, and
the light field of the blue (B) image channel of the color image flat slice into the waveguide system 5.

G) The waveguide system 5 for each flat slice of the color image multiplies:
the light field of the red (R) image channel of the color image flat slice,
the light field of the green (G) image channel of the color image flat slice,
the light field of the blue (B) image channel of the color image flat slice.
H) The polarizer 6 for each flat slice of the color image polarizes:
the multiplied light field of the red (R) image channel of the color image flat slice,
the multiplied light field of the green (G) image channel of the color image flat slice,
the multiplies light field of the blue (B) image channel of the color image flat slice.
I) Each said polarized light field falls successively, with a time shift, on the element 3a with a first optical power, and therefrom it falls on the tunable optical element 3b.

Under the effect of voltage for the red (R) image channel of the color image flat slice, the tunable optical element 3b is tuned such that
the light field of the red (R) image channel of the color image flat slice, which has passed the tunable optical element 3b and the element 3c with a second optical power, forms a real floating image of the red component (R) of the color image flat slice in a space at the distance corresponding to applied voltage;
the light field of the green (G) image channel of the color image flat slice, which has passed the tunable optical element and the element with a second optical power, forms a real floating image of the green component (G) of the color image flat slice in a space at the distance corresponding to the applied voltage;
the transmitted light field of the blue (B) image channel of the color image flat slice, which has passed through the tunable optical element and the element with a second optical power, forms a real floating image of the blue component (B) of the color image flat slice in a space at the distance corresponding to the applied voltage.

Moreover, the floating image of the red component (R) of the color image flat slice, the floating image of the green component (G) of the color image flat slice, and the floating image of the blue component (B) of the color image flat slice are formed successively, with a time shift, at the same distance.
J) (B)-(I) may be repeated for every flat slice of the color image. The sequence of floating images of R, G, B components of color image flat slices in a space, transmitted at a frequency exceeding the ability to see images as distinct images for the observer, forms a color volumetric floating image for the observer.

To reproduce the color floating volumetric video image in a space, the following may be carried out.
A) CAD system renders each digitized initial color volumetric image from the sequence of digitized initial color volumetric images making up the video image into a sequence of digitized flat color image slices. Each digitized flat slice of the color image includes a red component (R), a green component (G), and a component blue (B).

Each digitized flat slice of the color image comprises a signal containing red (R) image channel data, green (G) image channel data, blue (B) image channel data, and information on the distance at which a flat slice floating image is to be formed.

The sequence of digitized flat slices from the CAD system is stored as a sequence of said signals in the image source 1. Where necessary, the sequence of digitized flat slices is fed from the image source 1 to the electronic control unit 2.

For each digitized initial color volumetric image:
B) The electronic control unit 2 divides each signal from the sequence of digitized flat slices into:
a signal containing red (R) image channel data of the color image flat slice,
a signal containing green (G) image channel data of the color image flat slice,
a signal containing blue (B) image channel data of the color image flat slice,
a voltage signal for the red (R) image channel of the color image flat slice, whose value corresponds to information on the distance from the device, at which a floating image of the red (R) image channel of the color image flat slice is to be formed,
a voltage signal for the green (G) image channel of the color image flat slice, whose value corresponds to information on the distance from the device, at which a floating image of the green (G) image channel of the color image flat slice is to be formed, and
a voltage signal for the blue (B) image channel of the color image flat slice, whose value corresponds to information on the distance from the device, at which a floating image of the blue (B) image channel of the color image flat slice is to be formed.

The distance at which a floating image of the red (R) image channel of the color image flat slice is to be formed, the distance at which a floating image of the green (G) image channel of the color image flat slice is to be formed, and the distance at which a floating image of the blue (B) image channel of the color image flat slice is to be formed, are equal to the distance at which a floating color image of the color image flat slice corresponding to the initial color image is to be formed.
C) The electronic control unit 2 sends to the tunable optical element 3b, for each color image flat slice successively, with a time shift, and at a frequency exceeding the ability to see images as distinct images for the observer:
a voltage for the red (R) image channel, corresponding to the voltage signal for the red (R) image channel of the color image flat slice;
a voltage for the green (G) image channel, corresponding to the voltage signal for the green (G) image channel of the color image flat slice; and
a voltage for the blue (B) image channel, corresponding to the voltage signal for the blue (B) image channel of the color image flat slice.
D) the electronic control unit 2 sends to the projection unit 4 for each flat slice of the color image successively, with a time shift, at a frequency exceeding the ability to see images as distinct images for the observer:
a signal containing red (R) image channel data,
a signal containing green (G) image channel data,
a signal containing blue (B) image channel data.

Steps C) and D) are carried out synchronously.
E) The projection unit 4 converts for each flat slice of the color image successively, with a time shift:
the signal containing red image channel data (R) into a light field of the red (R) image channel of the color image flat slice;
the signal containing green (G) image channel data into a light field of the green (G) image channel of the color image flat slice;
the signal containing blue (B) image channel data into a light field of the blue (B) image channel of the color image flat slice.
E) the projection unit 4 projects for each flat slice of the color image successively, with a time shift:
the light field of the red (R) image channel of the color image flat slice,
the light field of the green (G) image channel of the color image flat slice, and
the light field of the blue (B) image channel of the color image flat slice to the waveguide system 5.
G) The waveguide system 5 multiplies:
the light field of the red (R) image channel of the color image flat slice,
the light field of the green (G) image channel of the flat slice of the color image, and
the light field of the blue (B) image channel of the color image flat slice.
H) The polarizer 6 of the tunable optical power system 3 polarizes:
the multiplied light field of the red (R) image channel of the color image flat slice,
the multiplied light field of the green (G) image channel of the color image flat slice, and
the multiplied light field of the blue (B) image channel of the color image flat slice.
I) Each said polarized light field falls successively, with a time shift, on the element 3a with a first optical power, and therefrom on the tunable optical element 3b.

Under the effect of voltage for the red (R) image channel of the color image flat slice, the tunable optical element 3b is tuned such that:
the light field of the red (R) image channel of the color image flat slice, which has passed through the tunable optical element 3b and the element 3c with a second optical power, forms a real floating image of the red component (R) of the color image flat slice in a space at the distance corresponding to the applied voltage;
the light field of the green (G) image channel of the color image flat slice, which has passed through the tunable optical element 3b and the element 3c with a second optical power, forms a real floating image of the green component (G) of the color image flat slice in a space at the distance corresponding to the applied voltage;
the transmitted light field of the blue (B) image channel of the color image flat slice, which has passed through the tunable optical element 3b and the element 3c with a second optical power, forms a real floating image of the blue component (B) of the color image flat slice in a space at the distance corresponding to applied voltage.

The floating image of the red (R) component of the color image flat slice, the floating image of the green (G) component of the color image flat slice, and the floating image of the blue (B) component of the color image flat slice are formed successively, with a time shift, at the same distance.
J) For each flat color image slice from the sequence of digitized initial color volumetric images making up the volumetric video, steps (C)-(I) are repeated; the sequence of floating images of R, G, B components of flat color image slices from the sequence of digitized initial color volumetric images that make up the volumetric video in a space, transmitted at a frequency exceeding the ability to see images as distinct images for the observer, forms a color floating volumetric video for the observer.

If all the slices have the same depth, the volumetric effect is lost. If one image is used at one depth, then the user will see a floating flat image. If a sequence of images formed at the same depth is used, the user will see a flat floating video. If a sequence of images that make up the same scene at different depths is used, and each depth has its own image, then the user will see a floating volumetric image. If a sequence of images of different scenes at different depths is used, and the sequence contains for each scene a sequence of images of this scene at different depths, then the user will see a floating volumetric video.

A floating volumetric image is formed by rapidly changing the focal length, e.g., by changing the optical power of the tunable optical power system 3 synchronously with changing respective images projected from the projection unit 4. In other words, by switching images from the image source 1 simultaneously and simultaneously applying corresponding voltages to the tunable optical element 3b, thereby moving the images to appropriate distances from the user, an impression of a volumetric image can be created for the user (observer).

It is to be noted that when a liquid crystal cell is used as the tunable optical element 3b, a smooth variation in the voltage on the liquid crystal cell, e.g. along a sinusoid, gives rise to identical smooth rotation of liquid crystals in the cell. When voltage is varied abruptly, e.g. from minimum to maximum and back to minimum, the system will have some delay as the crystals need time to rotate. Therefore, the electronic control unit 2 has voltage information from the signal from the image source 1. Signal from the image source 1 enters the electronic control unit such that to vary voltage on the LCD cell smoothly, and not abruptly.

It is noted that if the tunable optical power system 3 is not used in the device, the color image will decompose into three planes, e.g., each of RGB colors (red, green, blue) will focus to its own separate plane due to chromatic aberration.

The image, having passed the waveguide system, may decompose into three R, G, B images, which are located in different planes. Further, to restore a single image, these R, G, B images should be supplied with a shift in time, during which the tunable optical power system is tuned. Thus, in the case of a color image, the electronic control unit, receiving a signal from the image source, divides the signal into image data that is sent to the projection unit, and a signal containing information on the value of voltage to be applied to the tunable optical element. The signal for the tunable optical element and the signal for the projection unit are each further divided into three signals, since there are three colors in the image, namely R, G, B, e.g., these three signals for the tunable optical element are slightly different voltages, and for the projection unit, correspond to voltages of R, G, B image. With this, focal length of the tunable optical power system is set for each image of every RGB color so that the images merge. With the same optical power of the tunable optical power system, the components (RGB, e.g., three R, G, B images) of the color image are formed at different distances from the display (at different depths), e.g., they are spaced apart. The operation frequency of the electronic control unit is to be increased by three times, e.g. during the same time unit as before, the electronic control unit sends to the projection system R, G and B components of the same image separately with a time shift, and three voltages are applied with the same time shift to the tunable optical element, which correspond to the same distances from the display, at which the floating R, G, B image components are formed. Thus, previously spatially spaced R, G, B components of one image merge in a single plane.

For example, to achieve the effect of merging RGB components of one volumetric floating image from 10 slices (depth planes) at the frequency of forming each slice of 24 Hz (24 Hz is a generally accepted frequency that exceeds the ability to see images as distinct images for a person), each of 10 slices (depth planes) is derived for three main colors, each color being encoded with at least four bits to produce 16 gradations of brightness for each color. Thus, it is necessary to have an operating frequency of the entire device of at least 2880 Hz.

For better understanding of the present disclosure, consider the following example.

There is one volumetric image (3D model in CAD computer modeling system), which is divided into slices at 10 depths by rendering. Therefore, there may be 10 slices corresponding to one volumetric floating image. If the image is not RGB (not color image), then each of 10 frames is sent to the projection unit 5, and 10 different voltages corresponding to every frame are applied to the tunable optical power system 3. If the image is RGB (color image), then each frame of 10 is decomposed into RGB components (e.g., into 3 separate frames, 30 frames in total) and fed to the projection unit 4. For each of 30 frames, corresponding voltage (30 voltage values) is applied to the tunable optical element 3b, and the voltage is such that R, G, B components of one slice of the volumetric floating image obtained from the waveguide system 5 are formed in the same plane. There are 10 different planes, and image components merge in each R, G, B plane.

When a floating image is projected, as a result of dispersion, particularly, as a result of difference in refractive indices of all optical materials of the device for different wavelengths (different colors), longitudinal and transverse chromatic aberrations appear, which distort the floating image. Such distortions are corrected as follows. As described above, the projection unit 4 projects a color image or video received from the electronic control unit 2 in a form of a sequence of red (R, frame #1) images, green (G, frame #2) images, and blue (B, frame #3) images at a certain frequency, which together make up the respective displayed slice of the volumetric floating image. As described above, the frequency is to be such that the rate of changing slices of the volumetric floating image exceeds the ability to see the images as distinct images for the user. To correct chromatic aberrations, the electronic control unit 2 instructs the tunable optical power system 3 at the same frequency to vary its optical power from D(R) to D(G) and then to D(B), where D(R)>D(G)>D(B), to merge and focus all the R, G and B components of image at a certain depth and thereby eliminate the effect of aberrations. To do this, the frame rate of the projection unit 4 may be equal to the product of:
frame rate of image/video received from the image source 1,
number of displayed depth planes, determined by resolution of the volumetric image in depth,
number of main colors (e.g., red, blue, green, thus 3).

For example, for the frequency of 24 Hz, 10 depth planes/volumetric image slices and 3 main colors (R, G, B), and a reasonable selection of color depth (for example, 4 bits), the projector frame rate may be 2880 Hz, which is feasible for existing projectors. Color in computer image processing is encoded in bits. 4 bits may refer, for example, to each image pixel taking on any intensity value in the range from 0 to 15 intensity gradations of a given color, where 0 corresponds to minimum intensity, and 24-1 (e.g., 15) corresponds to maximum intensity of this color. Final information capacity of the image in bytes depends on the color depth. Thus, for the types of projectors listed above, capacity of the data transmission channel allows transmission and reproduction of color images with a depth, for example, 12 bits (4 bits×3 colors) for the entire image: for a frame rate of 24 frames per second, ×10 depth planes, ×3 colors×4 frames (bit-plane)/color, frame output rate of 2880 frames per second is required for pulse-length modulation of intensity of a full-color image, for example, a DMD projection system operates at a frequency of up to about 16 kHz, and a FLCoS projector system operates at frequencies up to about 6 kHz.

Size of the floating image depends on optical power of the tunable optical power system 3 and the R, G, B radiation wavelength. The electronic control unit 2 performs scaling of initial video/image for every volumetric image slice and R, G, B colors to keep constant size of the color volumetric image in all slices. The lower is the optical power of the tunable optical power system 3, the larger the image that may be decreased to obtain a volumetric image with a constant slice size, and vice versa. The larger is the wavelength of incident radiation, the larger the image that may be decreased, and vice versa. Such scaling of R, G, B images is well known in the art.

The floating image display device operates in the optical power ranges of elements 3a and 3c with positive and negative optical power elements (for example, lenses) that are part of the tunable optical power system 3. A main parameter of the tunable optical power system 3 is the relation of optical powers of optical elements 3a and 3c (lenses). Calculations show that the greatest depth of volumetric floating image is obtained when the relation is approximately 1.1 (either −1.1 or 1.1 in absolute value). If a liquid crystal cell is used as the tunable optical element 3b, thickness of the liquid crystal layer is calculated based on said optimal relation.

To calculate the floating image display device, the following parameters may be determined:
size of aperture,
f-number (value showing the relation of focal length f to maximum aperture size D, f-number=f/D),
relation of optical power s of two optical elements 3a and 3c (lenses), it may belong to the range from −1.05 to −1.15,
optically active material used in the tunable optical element 3b, the choice of which in this disclosure may be determined by value Δn of optical anisotropy (anisotropy of the refractive indices). The higher the value of optical anisotropy, the greater the amount of tuning the focal length of the tunable optical power system 3 can be achieved,
thickness of optically active material layer of the tunable optical element 3b. The calculations are made on the basis of following relationships based on matrix optics.

The key relationships are as follows.

For thickness of optical active material layer of the tunable optical element 3b:

$$l = \frac{- ( {n}_{-} \cdot {D}_{1}^{2} - Δ t \cdot {D}_{1} \cdot {D}_{2} \cdot ( {D}_{1} + {D}_{2} ) \cdot {n}_{+} ) \pm sqrt ( 1 )}{2 \cdot \frac{Δ t \cdot {( {D}_{1} \cdot {D}_{2} )}^{2}}{{n}_{1} \cdot {n}_{2}}} \qquad ( 1 )$$

For amount of tuning the tunable optical power system 3 (maximum difference in focal lengths that the tunable optical power system can focus on):

$$Δ t = \frac{- l \cdot {n}_{-} \cdot {D}_{1}^{2}}{{( {D}_{1} + {D}_{2} )}^{2} + \frac{{( l \cdot {D}_{1} \cdot {D}_{2} )}^{2}}{{n}_{1} \cdot {n}_{2}} - l \cdot {D}_{1} \cdot {D}_{2} \cdot ( {D}_{1} + {D}_{2} ) \cdot {n}_{+}} \qquad ( 2 )$$

For optical power value of positive optical power lens:

$${D}_{1} = \frac{( t \cdot k + t + \frac{l}{{n}_{1}} ) \pm sqrt ( 2 )}{2 \cdot \frac{t \cdot l \cdot k}{{n}_{1}}} \qquad ( 3 )$$

$$where$$

$$sqrt ( 1 ) = {( {n}_{-} \cdot {D}_{1}^{2} - Δ t \cdot {D}_{1} \cdot {D}_{2} \cdot ( {D}_{1} + {D}_{2} ) \cdot {n}_{+} )}^{2} - 4 \cdot \frac{{( Δ t \cdot {D}_{1} \cdot {D}_{2} \cdot ( {D}_{1} + {D}_{2} ) )}^{2}}{{n}_{1} \cdot {n}_{2}}$$

$$sqrt ( 2 ) = {( t \cdot k + t + \frac{l}{{n}_{1}} )}^{2} - 4 \cdot \frac{t \cdot l \cdot k}{{n}_{1}}$$

$$\frac{1}{{n}_{1}} - \frac{1}{{n}_{2}} = {n}_{-}$$

$$\frac{1}{{n}_{1}} + \frac{1}{{n}_{2}} = {n}_{+}$$

$$Δ t = {t}_{1} - {t}_{2}$$

$$k = \frac{{D}_{2}}{{D}_{1}} , k \neq 0 , k \neq 1 ,$$

In this context:
D₁—optical power value of positive optical power element (3a or 3c) (lens, lens system); D₂—optical power value of negative optical power element (lens, lens system) (3a or 3c);
1—thickness of optically active material layer of tunable optical element 3b;
Δt—amount of tuning (changing) focal length of the tunable optical power system 3;
t₁—initial distance (before tuning) at which beams passing through the tunable optical power system 3 are focused;
t₂—distance at which beams are focused as a result of tuning the tunable optical power system 3;
n₁·n₂—refractive indices of optically active material of tunable optical element 3b, switching between which by varying the voltage applied to the tunable optical element 3b tunes focal length of the entire tunable optical power system 3. For example, for liquid crystals, refractive indices of ordinary and extraordinary rays are taken as n₁·n₂;
n₋n₊—values defining the amount of changing the refractive index of optically active material of the tunable optical element 3b;
κ—relation of optical power s of elements 3a and 3c (lenses, lens systems) with fixed optical power.

It is to be understood that increasing the thickness of the layer of an optically active material of the tunable optical element 3b (for example, liquid crystals) increases the tuning range. The thicker the liquid crystal layer, the greater will be the tuning range of the tunable optical power system 3, e.g., change in the focal length at which rays passing through the tunable optical power system 3 are focused. Increasing the tuning range will lead to a “deeper” or more volumetric image resulting from such tuning of the focal length.

To find thickness of an optically active material according to formula (1), it is necessary to select a material with the highest optical anisotropy of the material (liquid crystals); select relation of optical power s of elements 3a and 3c (lenses, lens systems) with fixed optical power s, for example, from the range from −1.05 to −1.15; select the amount of necessary tuning (varying the focal length) of the tunable optical power system 3, which is determined by the required perception of depth of the 3D image.

The specific order of selecting the parameters in formulas (1)-(3) does not affect the final result, particularly, image quality and perception of depth of 3D object, e.g., its realism. When parameters outside of the ranges are selected, the present disclosure will work, but possibly with worse image quality and depth perception of the 3D object.

To find the magnitude of optical tuning of the tunable optical power system 3 according to formula (2), it is necessary to select a material with the highest optical anisotropy of the material (liquid crystals); select relation of optical power s of elements 3a and 3c (lenses, lens systems) with fixed optical power s, for example, from the range −1.05 to −1.15; select the required thickness of the layer of optically active material of the tunable optical element 3b, which is determined by form factor of the system and manufacturing capabilities of the tunable optical element 3b with a selected thickness.

To find the magnitude of optical power of elements 3a and 3c (lenses, lens systems) with fixed optical power s according to the formula (3), it is necessary to select a material with the highest optical anisotropy of the material (liquid crystals); select the value of relation of optical power s of lenses with fixed optical power s, for example, from the range −1.05 to −1.15; select one of values of focal length at which rays that have passed through the tunable optical power system 3 will be focused, which may certainly be at the boundaries of the optical tuning range of the tunable optical power system 3. For example, if liquid crystals with a certain amount of optical anisotropy have been chosen as the optically active material, then it is possible to select a focal length value corresponding to refractive index of ordinary ray or refractive index of extraordinary ray for these liquid crystals.

In liquid crystal tunable optical cells, the “tuning” of focus may be carried out using electrodes that make up the electrode structure in each tunable optical element 3b.

The mechanism of “tuning” electrodes may be based, for example, on two principles.

The first principle implements automatic selection of addressable electrodes, e.g., the electrodes in the electrode structure of a tunable optical element 3, to which the voltage corresponding to them is applied. Automatic selection of addressable electrodes is associated with the choice of required optical power. Optical power depends on the number of Fresnel zones, e.g., addressable electrodes are selected depending on the number and location of Fresnel zones activated by them. Here it is suggested to clarify that formation of Fresnel zones is determined by the shape, size and location of electrodes, as well as the value of voltage applied to these electrodes. Fresnel zones are regions, into which the light wave surface can be divided to calculate results of light diffraction. After passage of light through an optical element having an optical power, the light wave surface can be divided into Fresnel zones, the number and size of which correspond to optical power of this optical element. A method for calculating Fresnel zones and calculating optical power of a diffractive lens is described in RU 2719341 C1 (publication date 17 Apr. 2020). Thus, optical power and efficiency of an optical element based on liquid crystals is primarily determined by the size, shape, location of electrodes and voltage applied to them, and methods for calculating, arranging, choosing the material of the electrodes are known (for more details, see e.g. RU 2719341 C1 (publication date 17 Apr. 2020).

In accordance with the second principle, values of voltages applied to the electrodes are estimated from the dependence of voltage on phase characteristic of any optically active material (e.g., a material capable of introducing a phase delay at variation in the applied voltage when light propagates through it). When choosing an optically active material for a tunable optical element 3b, it is necessary to know the dependence of phase delay of the light passing through the material on voltage at electrodes of the electrode structure. Then, to simulate introduction of a certain optical power, it is necessary to apply voltages to the electrodes such that the phase delay profile of out-coupled light corresponds to that of an ideal thin lens with the same optical power. This entire process can be automated using standard algorithms well known in the art (for more details see e.g. US20150277151 A1 (publication date 1 Oct. 2015).

In the disclosure, the tuning of focal length of a tunable optical element 3b with an optically active substance is implemented on the basis of the second principle. Hereinafter, unless otherwise indicated, tuning of a tunable optical power system refers to tuning (e.g., changing in a certain range) the focal length (or optical power, which is equal to the reciprocal of the focal length), at which this tunable optical force system focuses rays of a certain range of wavelengths, passing through it.

To generate an electric field, which is necessary to change refractive index of a tunable optical element 3b, and, as a result, change optical power of the entire tunable optical power system 3, an electrode coating is used. The coating can be applied in the form of one-dimensional coating, stripes, circles, and in the general case, the coating may have any arbitrary shape to change refractive index of the tunable optical element (for example, in liquid crystals under the electrode, electric field is stronger than in the space of liquid crystals, above which there is no electrode).

By way of example, and not limitation, electrodes in the electrode structure of every tunable optical cell may be made of indium tin oxide (ITO). In various embodiments, the electrodes may be made from other transparent conductive materials widely known to those skilled in the art (e.g. indium oxide, tin oxide, indium zinc oxide (IZO), zinc oxide).

The electrode is applied to a substrate that is transparent in the visible wavelength range and is typically made of glass or plastic. Moreover, the tunable optical element may include two substrates with the electrode deposited on one of the surfaces of each substrate. The optically active layer is disposed between surfaces of the substrates, on which the electrodes are deposited.

As a layer of liquid crystals, a single cell of liquid crystals can be used, in this case the layer of liquid crystals is divided into smaller cells, e.g., instead of one large cell, a mosaic of smaller cells may be used. This division takes place in production, in conventional processes, like pixels in a conventional display. Such cells are needed to obtain required properties, for example, ease of control. Individual control of each cell is easier than control of one large cell. Furthermore, these cells usually require lower voltage to control than one large one, and they are also easier to produce. When rays projected by the projector fall on a layer of liquid crystals (both a single large cell and a set of small cells), the optical phase shifts, which increases optical power of the system.

Multiple tunable optical elements can be combined, in this case they are arranged one after another. The layer of liquid crystals may contain not one cell, but a plurality of cells. Through a plurality of liquid crystal cells arranged one after another, rays propagate with an increasing phase shift. Thus, instead of using one thick liquid crystal cell, a set of thin liquid crystal cells can be used, while the operation of the device does not fundamentally change.

When combining several tunable optical elements, it is possible to use a combination of a liquid crystal layer with a single cell and with a plurality of cells, as well as a combination of positive and negative optical elements (lenses) in any sequence. The more there are layers of liquid crystals, the larger tuning. Each layer can be controlled individually, while the tuning range increases. Thickness of one layer of liquid crystals is no more than 30 microns.

Instead of conventional fixed optical elements (lenses, lens systems), it is possible to use liquid crystal lenses, and to place a layer of liquid crystals between such liquid crystal lenses.

Lenses may have a variety of shapes that meet manufacturing requirements for the display form factor.

Lenses can be coated with a variety of coatings such as polarizing, anti-reflection, and filters can be applied to allow only certain wavelengths to pass through. Such coatings are necessary to reduce radiation losses in the system (to reduce reflection).

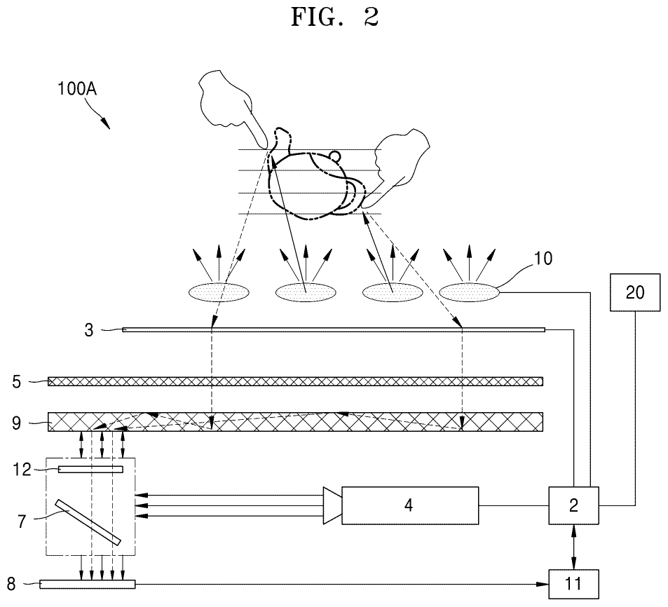

In accordance with the present disclosure, the user (observer) can not only observe/view a volumetric floating image, but also interact with the volumetric floating image. In other words, the disclosure can be used as an interactive display of a volumetric floating image. The interactive floating display system shown in FIG. 2 is designed such that the user can interact with the system, and the floating image display device can respond to the user's input immediately or after some time.

The interactive floating image display system 100A shown in FIG. 2 comprises the floating image display device described above, further including an infrared (IR) waveguide, an IR backlight source, a beam splitter, and an IR detector. Thus, the interactive floating image display system comprises an image source 1, an electronic control unit (e.g., including circuitry) 2, a projection unit (e.g., including a projector) 4, a beam splitter 7,
an IR detector 8,
an IR waveguide 9, a waveguide system 5 and
a tunable optical power system (e.g., including an optically active material)_3.

The interactive floating image display system may further include an IR backlight unit (e.g., including an IR backlight) 10, a control module (e.g., including circuitry) 11, and a lens 12.

The image source 1 is optically coupled to the beam splitter 7 and the lens 12. The IR waveguide 9 is arranged between the beam splitter 7 and the waveguide system 5. For example, the IR waveguide 9 may be arranged between the lens 12 and the waveguide system 5. The IR backlight unit 10 is arranged to illuminate the entire area of floating image. The control module 11 is connected to the IR detector 8 and the electronic control unit 2. The electronic control unit 2 is connected to the IR backlight unit 10 and is further configured to send a control signal to the IR backlight unit 10. The tunable optical power system 3 is further configured to collimate IR radiation scattered by the user. The waveguide system 5 is transparent to IR radiation. The beam splitter 7 is configured to transmit scattered IR radiation to the IR detector 8. The IR detector 8 is configured to receive scattered IR radiation that has passed through the beam splitter 7 and transmit it to the control module 11. The control module 11 is configured to detect the fact of user interaction with the floating image area, as well as the place of interaction in the floating image area, and generate a command corresponding to location of the place of interaction with the floating image area.

The interactive floating image display system 100A may operate, for example, in the following manner.

The electronic control unit 2 generates a control signal for a tunable optical element (refer to the tunable optical element 3b of FIG. 1, not shown as a separate element in FIG. 2) of the tunable optical power system 3. Responsive to the control signal, the tunable optical element 3b sets the focus to a certain depth corresponding to the depth of the reproduced floating image.

Operating wavelength may be near-IR wavelength, e.g. 860 nm. The interactive floating image display system 100A operates in consequential mode, where formation of a floating image and feedback to the user take place in turn. In the consequential working mode, signals from the projection system 4 and from the IR backlight unit 10 are pulsed and shifted in time. Thus, IR signal (shown in FIG. 2 by solid arrows coming from the IR backlight unit 10) and signals that form a floating image (shown in FIG. 2 as a teapot image) alternate. In this case, visible radiation that may fall on the IR detector 8 will not be taken into account, since the IR signal and the signal that forms the volumetric floating image will fall on the IR detector 8 at different times. When operation frequency of the device exceeds the ability to see images as distinct images for a person, the user has a feeling of synchronous operation of the response system with the volumetric floating image generating system.

The electronic control unit 2 generates a control signal transmitted to the IR backlight unit 10. The control signal can cause the IR backlight unit 10 to operate in both pulsed and non-pulsed modes. The IR backlight unit 10 illuminates the floating image area in space; in FIG. 2 solid arrows coming from the IR backlight unit 10 indicate IR radiation illuminating the floating image area. The IR backlight unit 10 provides maximum density of illumination power over the entire volume of the floating image.

When the user brings a hand or an object to the floating image area, the IR light illuminating the floating image area is scattered; in FIG. 2 dotted arrows denote user-scattered radiation. The radiation scattered by the user or the object is collimated by the tunable optical power system 3 and is directed through the waveguide system 5. Moreover, the waveguide system 5 is configured such that the scattered IR radiation passes through it without hindrance, e.g., the waveguide system 5 is transparent to scattered IR radiation, which is achieved by the choice of parameters of diffractive optical elements of the waveguide system 5; the basic parameter in this case is the period of the diffractive optical elements of the waveguide system 5, such systems are known from the prior art. Next, the scattered IR radiation enters the IR waveguide 9, which is configured to in-couple, transfer and decouple scattered IR radiation toward the beam splitter 7 through the lens 12, such waveguides are known from the prior art. The lens 12 operates in several spectral ranges and serves as an element of projection optics operating in the RGB range and an element for receiving scattered IR radiation.

The beam splitter 7 transmits scattered IR radiation to the IR detector 8 with a narrow-band IR filter. The narrow-band IR filter transmits only the radiation of the IR backlight unit 10 and does not transmit radiation of other ranges.

The scattered IR radiation that falls on the IR detector 8 is processed (e.g. by image processing algorithms) to determine coordinates of the objects that fall into the floating image area.

To estimate the depth of interaction of the object with the floating image area, the tunable optical power system 3 scans through available depth range, e.g., the tunable optical power system 3 is sequentially tuned from minimum depth to maximum depth and back to perceive IR radiation in order to detect a user hand or an object.

Processing images from the IR detector enables recognition of the object that the user is using, or face or fingerprint recognition by conventional methods.

The electronic control unit 2 generates a signal that is fed to the tunable optical element 3b of the tunable optical power system 3. As described above, the tunable optical power system 3 changes the focus for scanning the depth; the electronic control unit 2 generates a pulse signal, which is sent to the IR backlight unit 10. The IR backlight unit 10 illuminates the area in which a volumetric floating image has been formed. When an object, for example, a user's hand, enters the image volume, IR radiation is scattered by this object, and rays of the scattered IR radiation fall on the tunable optical power system 3, where they are collimated. Next, the collimated scattered IR radiation enters the IR waveguide 9 through an in-coupling diffraction grating. The radiation propagates along the IR waveguide 9 due to total internal reflection from the walls of the IR waveguide 9, and through an out-coupling diffraction grating (not shown in the figures as a separate element) is out-coupled from the IR waveguide 9 and enters the lens 12, which operates in several spectral ranges and serves as an element of projection optics that operates in the RGB range and an element for receiving scattered IR radiation. The radiation enters the beam splitter 7, which separates useful IR radiation from visible one; in this case, the visible radiation is glare and spurious reflections. The separated IR radiation enters the IR detector 8. The IR detector 8 may have a narrow-band IR filter that transmits only necessary IR radiation, thereby improving the signal-to-noise ratio. The radiation that has passed into the IR detector 8 is processed by the control module 11, which calculates coordinates of the location where the user interacted with the floating image.

In parallel working mode, signals from the projection unit 4 and from the IR backlight unit 10 are sent at the same time. This mode increases brightness, but decreases the signal-to-noise ratio of the user response system.

In consequential working mode, signals from the projection system 4 and from the IR backlight unit 10 operate in a pulsed mode and are shifted in time. Thus, the IR back-response signal and the signal that forms a volumetric floating image alternate. In this case, visible radiation that may fall on the IR detector 8 will not be taken into account, since the IR back-response signal and the signal that forms the volumetric floating image fall on the IR detector 8 at different times. In this embodiment, brightness is slightly lost, but signal-to-noise ratio of the user response system is significantly increased.

The IR backlight unit 10 can be integrated in the projection unit 4. Since the waveguide system 5 is transparent to IR radiation, and the IR waveguide 9 senses IR radiation, the IR waveguide 9 can be combined with the waveguide system 5. User tracking devices may also be used.

An array of ultrasonic transmitters 20 can be used together with the volumetric floating image device 100. The ultrasonic transmitters 20 transmits ultrasonic signal to the floating image area for user interaction with the floating image area. Modulation of the wave phase of each transmitter enables focusing the signal from the ultrasonic transmitters 20 to any area of the floating image area. In other words, having received signals on user interaction with the floating image area, the electronic control unit 2 instructs the control module 11 to transmit the signal from ultrasonic transmitters 29 to the area where the object is located. Thus, a tactile back response can be implemented, which will signal to the user about “pressing” on any element of the floating image, e.g., the user has the feeling that he really touched the image.

In addition, the system 100A can be tuned such that when a certain part of the floating image is “pressed”, e.g., when a signal from the detector about reception of scattered radiation in a certain part of the floating image is received, the system 100A will emit a sound signal corresponding to this part of the floating image. The user may also receive response from interaction with the floating image in the form of image change.

Thus, the control module 11 can be connected to any necessary transmitters, which, at the command of the control module, can transmit radiation of visible range, invisible range, e.g., radiation of any ranges suitable for user interaction, as well as sound and ultrasound, to the floating image area.

Therefore, the present disclosure provides formation of a floating image projected in the air; the image has a large size, a wide viewing angle, e.g., the image can be seen from different angles; brightness of the floating image does not depend on the viewing angle of the floating image, and the user can interact with the floating image and receive response.

The present disclosure excludes and/or reduces physical interaction of the user with any surface to receive information/response or to enable and work with any device. The user simply moves finger to a place in the air where the floating image of a button is visible, and the device with a floating control panel performs action corresponding to “pressing” the button.

The floating image display device can be used not only as an image display, but also in creating a holographic user interface when the user interacts with e.g. household appliances such as a refrigerator, cooktop, TV, air conditioner, intercom, etc., and the floating image display device can also find application in hazardous industries. Thus, control elements can be displayed floating in a space. In this case, an additional camera can be used to detect:
explicit interaction, which can be expressed by user gestures. Gestures can be symbolic (e.g. raising the thumb), deictic (e.g. pointing), iconic (e.g. mimicking a specific movement), and pantomime (e.g. using an invisible instrument);
implicit interaction (proxemics). Here, proxemics is understood as a sign system in which the space and time of organization of communication process have a semantic load. For example, if two users who have mobile devices with the floating image display form a floating volumetric image of the other party (called hologram in this case and possibly not identical to the size of the user's body) using the floating image display, then since the present display can project dynamic images, holograms of the parties can change with time and context of communication. Furthermore, such a modification of a volumetric image can occur both with participation of the user (using gestures, pressing buttons, voice control, user eye movements, etc.), and without his participation, using a preprogrammed reaction (e.g., visual change of 3D image) responsive to the other party's message. It should be understood here that communication between holograms of conversation parties can occur without active actions on the part of users, for example, if the floating image display is used with additional sensors for position and reactions of the user's body.

The use of multiple handheld and portable devices can add additional context-sensitive features for interacting with generated floating images. For example, they can act as a temporary space to transfer information from one hologram to another.

The present disclosure can be used to recognize a fingerprint or hand, it is also possible to recognize user's face. Such devices can be used as a lock that, when opened, recognizes the user's face or hand or any other limb.

While the present disclosure has been described with reference to various illustrative embodiments, it will be appreciated that the disclosure is not limited to these example embodiments. The disclosure is intended to include all alternatives, corrections, and equivalents that may be included within the spirit and scope of the disclosure, including the appended claims and their equivalents. It will also be understood that any of the embodiment(s) described herein may be used in conjunction with any other embodiment(s) described herein.

What is claimed is:

1. A floating image display device, comprising:
an image source comprising memory;
an electronic control unit comprising at least one processor comprising processing circuitry;
a tunable optical power system comprising an optically active material;
a projection unit including a projector; and
a waveguide system including at least one waveguide;
wherein
the image source is connected to the electronic control unit and configured to store a digitized image in the memory and output to the electronic control unit, the digitized image in a form of a signal containing data of an initial image and information on a distance from the floating image display device, at which an image corresponding to the initial image is to be formed;
the electronic control unit is connected to the tunable optical power system and to the projection unit, the electronic control unit being configured to divide the signal into a signal containing the data of the initial image and a signal containing data of voltage whose value corresponds to the information on the distance;
the projection unit is optically coupled to the waveguide system and is configured to convert the signal containing the data of the initial image into a light field corresponding to the initial image;
the waveguide system is optically coupled to the tunable optical power system and is configured to multiply light beams comprising the light field;
wherein the tunable optical power system comprises a polarizer, a first element comprising at least one lens with a first optical power, a second element comprising at least one lens with a second optical power and a tunable optical element comprising an optically active material located between the first and second elements.

2. The device of claim 1, wherein the polarizer is configured to polarize the multiplied light beams from the waveguide system such that polarization direction of the light beams coincides with polarization direction of the tunable optical element; and
wherein the first element is configured to direct the polarized light beams that have passed through the polarizer toward the tunable optical element.

3. The device of claim 2, wherein the tunable optical element is configured to introduce a phase delay to a wavefront of the passing light field, thereby changing the distance at which a floating image is to be formed in a space, based on a voltage applied by the electronic control unit; and
the second element is configured to focus the light beams comprising the light field corresponding to the initial image and out-coupled from the tunable optical element, in the space, forming a floating image at a distance corresponding to the voltage applied to the tunable optical element.

4. The device of claim 1, wherein the first element includes a positive optical power element, and the second element includes a negative optical power element.

5. The device of claim 4, wherein optical power D_{Pos} of the positive optical power optical element is related to optical power D_{Neg} of the negative power optical element based on:
$${D}_{Pos} = - 1.1 \times {D}_{Neg} .$$

6. The device of claim 1, wherein the first element includes a negative optical power element, and the second element includes a positive optical power element.

7. The device according to claim 1, wherein there is no air gap between the first element, the tunable optical element and the second element.

8. The device according to claim 1, wherein the tunable optical element comprises an optically active material configured to change optical properties based on an applied voltage.

9. The device according to claim 1, wherein the image source comprises the memory storing data on each slice of the image, including a digitized image of a slice and data on a slice depth.

10. A method for operating a floating image display device to display a flat floating image, comprising:
A) outputting, by an image source, a digitized initial flat image, which enters to an electronic control unit comprising processing circuitry, wherein the digitized initial flat image includes a signal containing data of the digitized initial flat image and information on a distance at which a flat floating image, corresponding to the digitized initial flat image, is to be formed;
B) processing, by the electronic control unit, the signal, dividing, by the electronic control unit, the signal into a signal containing the digitized initial flat image data and a voltage signal having a value corresponding to the information on the distance to the floating image display device, at which the flat floating image is to be formed;
C) applying, by the electronic control unit, a voltage corresponding to the voltage signal to a tunable optical element comprising an optically active material;
D) sending to a projection unit, including a projector, by the electronic control unit, the signal containing said initial flat image data;
D) converting, by the projection unit, the initial flat image data into a light field corresponding to the initial flat image, and projecting, by the projection unit, the light field to a waveguide system;
E) multiplying, by the waveguide system, a set of light beams comprising the light field; and
F) polarizing, by a polarizer of the tunable optical power system, the multiplied light field out-coupled from the waveguide system.

11. The method of claim 10, further comprising:
F) applying the polarized light field to a first element comprising at least one lens and having a first optical power, to the tunable optical element, wherein based on the voltage, the tunable optical element is tuned such that the light field that has passed through the tunable optical element and a second element comprising at least one lens and having a second optical power, forms a flat floating image corresponding to the initial flat image in a space at a distance corresponding to the applied voltage.

12. An interactive floating image display system, comprising:
a floating image display device according to claim 1;
a beam splitter;
an infrared (IR) detector;
an IR waveguide disposed between the beam splitter and a waveguide system;
an IR backlight unit including an IR backlight;
a control module, comprising processing circuitry, connected to the IR detector and an electronic control unit comprising circuitry.

13. The system of claim 12, wherein
the electronic control unit is connected to the IR backlight unit and is further configured to send a control signal to the IR backlight unit;
the tunable optical power system is further configured to collimate IR radiation scattered by the user;
the waveguide system is transparent to IR radiation;
the IR backlight unit is configured to illuminate a floating image area;
the beam splitter is configured to transmit scattered IR radiation to the IR detector;
the IR detector is configured to detect scattered IR radiation that has passed through the beam splitter and to transmit the scattered IR radiation that has passed through the beam splitter to the control module;
the control module is configured to detect user interaction with the floating image area, and the place of interaction on the floating image area, and generate a command corresponding to location of the place of interaction with the floating image area.

14. The system of claim 12, wherein the IR waveguide is integrated with the waveguide system.

15. The system according to claim 12, further comprising an array of ultrasonic transmitters which transmits ultrasonic signal to the floating image area for user interaction with the floating image area.
